(19) United States
(12) Patent Application Publication
(10) Pub. No.: US 2013/0268367 A1
(43) Pub. Date: Oct. 10, 2013

(54) COMUPTERIZED MARKETING AND ADVERTISING PLATFORM BASED ON SOCIAL NETWORKS

(71) Applicant: NEBI CEM ERDOGAN, Atlanta, GA (US)

(72) Inventor: NEBI CEM ERDOGAN, Atlanta, GA (US)

(21) Appl. No.: 13/438,915

(22) Filed: Apr. 4, 2012

(51) Int. Cl. G06Q 30/02; G06Q 50/00

(52) U.S. Cl. CPC G06Q 30/0277; G06Q 50/01
USPC 705/14.64; 705/14.73

(57) ABSTRACT

Described herein are methods and systems allowing a merchant to market its brands, products and/or services through its customers' social network platforms. In particular, a computerized advertising platform generates and tracks social network activities of participating customers in exchange of honoring related marketing incentives. Using this platform, a merchant can submit bargain items, and in exchange for receiving a bargain item, a customer authorizes an echo message regarding the merchant and bargain item to be posted on his or her social network account(s).

### FIELD OF THE INVENTION

The present invention relates generally to e-commerce using social network platforms, and more particularly, to methods and systems allowing a merchant to market and advertise its brands, products and/or services by tracking participating customers' social network activities.

### BACKGROUND

The proliferation of social network sites over the Internet allows people to quickly connect with their friends, make new contacts and share information in a global scale. Many merchants have increasingly adopted social networks as another marketing and advertising platform, in addition to conventional media such as newspaper, billboards, TV, radio and online search engine (e.g., Google). For example, some merchants may create a Facebook account for their customers to “like,” and some may start a Twitter account for their customers to “follow.” Having a social network account allows a merchant to connect with existing or potential customers. It may also allow the merchant to broadcast promotional messages such as a discounted deal or bargain to a wide audience. However, this marketing approach works more effectively for merchants that have well-known brand names and a sizable existing customer base. For new businesses or less established brands, having a social network account is no more than creating another a website, and the difficulty remains how to attract initial customers, secure a sufficient amount of viewing traffic, and ultimately win over a large target consumer base. In order to overcome such difficulty, many merchants have no choice other than resort to traditional business tools, such as starting a large-scale marketing campaign and making advertisements on various media, which, however, can be prohibitively expensive.

Alternatively, merchants can promote their products and services by offering purchase incentives directly to customers, such as free samples, discounts, points of credit and so forth. The rationale is, those who have received and enjoyed the incentives may not only become return customers themselves, but also help promote the merchants through their words of mouth in respective social circles. However, in order to redeem the deal or bargain or any merchant-provided incentive, customers often have to present a printed coupon, a barcode, a verification code and the like at the point of sale, which means an additional burden from the customers' perspective. Also, understandably, customers may be reluctant to endorse a merchant if the endorsement requires them to post a detailed review on the website (e.g., yelp.com), fill out an extensive questionnaire survey, or send a spam email to their friends and contacts, all of which can be quite burdensome, and sometimes, seemingly offensive.

In view of the above, there is conceivable benefit for a merchant to make use of its customers' social networks for purposes of marketing and advertising its products and services. On the other hand, customers need an easy, effective and non-intrusive application that allows them to share deal or bargain information with their social network connections while enjoying the merchant-provided incentive.

### SUMMARY OF THE INVENTION

The presently disclosed embodiments are directed to solving issues relating to one or more of the problems presented in the prior art, as well as providing additional features that will become readily apparent by reference to the following detailed description when taken in conjunction with the accompanying drawings.

One embodiment is directed to a method for promoting products and services via social network platforms, the method comprising: receiving bargain data from a merchant, the bargain data including one or more bargain items offered by the merchant; displaying a list of the one or more bargain items in a mobile device of a customer, the customer associated with one or more social network accounts; receiving a first input that selects at least one of the one or more bargain items; receiving a second input that authorizes posting an echo message regarding the selected bargain item to at least one of the one or more social network accounts associated with the customer; in response to the second input, posting the echo message on the at least one social network account associated with the customer; and allowing the customer to receive the selected bargain item from the merchant.

Another embodiment is directed to a non-transitory computer readable medium comprising executable instructions, the executable instructions, while executed, causing a processor to perform receiving bargain data from a merchant, the bargain data including one or more bargain items offered by the merchant; displaying a list of the one or more bargain items in a mobile device of a customer, the customer associated with one or more social network accounts; receiving a first input that selects at least one of the one or more bargain items; receiving a second input that authorizes posting an echo message regarding the selected bargain item to at least one of the one or more social network accounts associated with the customer; in response to the second input, posting the echo message on the at least one social network account associated with the customer; and allowing the customer to receive the selected bargain item from the merchant.

Yet another embodiment provides a device that comprises a screen display, a memory comprising executable instructions, and a processor configured to execute the executable instructions in the memory. The processor is further configured to display a list of bargain items on the screen display; receive an input from a user that selects at least one of the displayed bargain items, wherein the input authorizes posting an echo message regarding the selected bargain item to at least one social network account associated with the user; and access the at least one social network account associated with the user to post the echo message, wherein the user redeems the selected bargain items after the echo message is posted. The processor is also configured to receive bargain data submitted by a merchant, wherein the bargain data can be one or more bargain or deal items.

Further features and advantages of the present disclosure, as well as the structure and operation of various embodiments of the present disclosure, are described in detail below with reference to the accompanying drawings.

### BRIEF DESCRIPTION OF THE DRAWINGS

The present disclosure, in accordance with one or more various embodiments, is described in detail with reference to the following figures. The drawings are provided for purposes of illustration only and merely depict exemplary embodiments of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 is a high-level overview of an exemplary system in which embodiments of the invention can be implemented;

FIG. 2 is a flow diagram of an exemplary process from a merchant's perspective in which embodiments of the invention can be implemented;

FIG. 3 is a flow diagram of an exemplary process from a customer's perspective in which embodiments of the invention can be implemented;

FIGS. 4a-j illustrate exemplary screen shots of a mobile application in which embodiments of the invention can be implemented;

FIG. 5 is a simplified functional block diagram of an exemplary computer that can be implemented in the exemplary system of FIG. 1; and

FIG. 6 is a simplified functional block diagram of an exemplary mobile device that can be implemented in the exemplary system of FIG. 1.

### DETAILED DESCRIPTION OF EXEMPLARY EMBODIMENTS

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described herein and shown, but is to be accorded the scope consistent with the claims.

The word “exemplary” is used herein to mean “serving as an example or illustration.” Any aspect or design described herein as “exemplary” is not necessarily to be construed as preferred or advantageous over other aspects or designs.

Reference Will now be made in detail to aspects of the subject technology, examples of which are illustrated in the accompanying drawings, wherein like reference numerals refer to like elements throughout.

It should be understood that the specific order or hierarchy of steps in the processes disclosed herein is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Embodiments disclosed herein are directed to methods and systems allowing a merchant to market and advertise its brands, products and/or services using its customers' social networks. Particularly, a computerized advertising platform is provided for generating and tracking the social network activities of participating customers in exchange of honoring related marketing incentives. In one embodiment, the methods and systems allow a merchant to submit one or more bargain items and display the bargain items for a customer to view and select in a mobile device. In order to receive the selected bargain item, the customer needs to authorize an echo message regarding the merchant and bargain item to be posted on his or her social network account(s). As a result, the merchant can instantly reach all of the customer's social connections as its potential customers. Since each social connection of the customer likely has their own social network accounts, the echoing or snowballing effect would allow the merchant to expand its audience exponentially in a very short time frame.

As partial implementation of the methods and systems, a mobile device is provided according to another embodiment. In particular, the processor in the device is configured to display a list of bargain items on a screen display for a user to choose from. Once the user selects one of the displayed bargain items, the selection authorizes the processor to access one of the user's social network accounts to post an echo message regarding the selected bargain item and corresponding merchant. Then the user can redeem the selected bargain items from the merchant based on the echo message posted on his or her social network account or a confirmation message of such posting.

It should be appreciated that the embodiments described herein are illustrated by referring to currently-prevalent social network sites such as Facebook, LinkedIn, Twitter, Google+, etc., the application of these embodiments are not so limited, but can include any type of existing or future social network platforms that people may adopt in view of the continuous evolvement of technologies.

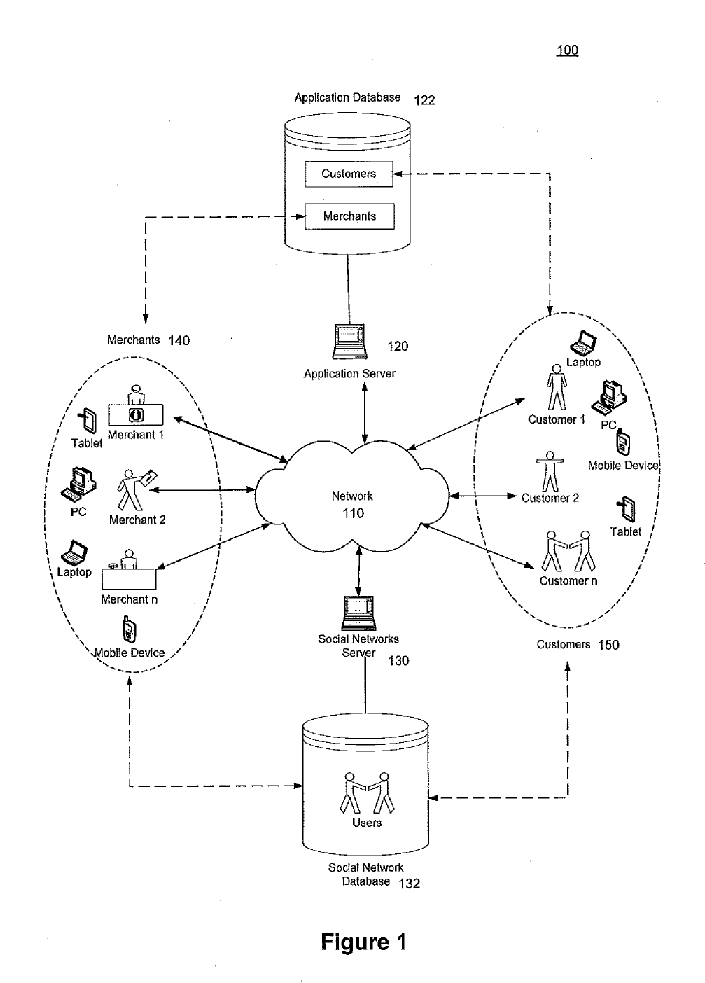

Referring to FIG. 1, illustrated therein is a high-level overview of an exemplary system 100 in which embodiments of the invention can be implemented. As shown in FIG. 1, the system 100 comprises a communications network 110 and a few entities connected to the network, including an application server 120, one or more social networks servers 130, merchants 140 and customers 150. The communication network 110 can be one or a combination of the following networks: the Internet, Ethernet, a mobile carrier's core network (e.g., AT&T or Verizon networks), a Public Switched Telephone Network (PSTN), a Radio Access Network (RAN), and other wired or wireless networks. Merchants 140 and customers 150 can be connected to the network 110 through one or multiple network devices, including a fixed or mobile subscriber unit, a pager, a cellular telephone, a personal digital assistant (PDA), a smart phone, a laptop, a netbook, a tablet computer, a personal computer, a wireless sensor, consumer electronic devices, and the like.

The system 100 comprises one or more social network servers 130 and one or more social network databases 132 for storing social network data. The users of social networks can be individuals such as customers 150 or business entities such as merchants 140. As used herein, the term “social network” includes, without limitation, social networking platforms, such as Facebook, LinkedIn, MySpace, Friendster, Twitter, Tumblr, Google+, Hi5, Instagram, Foursquare, Ning, etc. Also, the term “social network” includes social aggregators that consolidate information and updates from social websites such as social networks, social bookmarking sites and blogs, online virtual space or gaming community such as Second Life and Game Center, websites for sharing music, video, photos and various media content such as YouTube, Flickr and Picasa, services that allow websites external to social networks to access social network user data, such as Facebook Connect and MySpace Data Availability, and any other Web 2.0 platforms that allow users to make connections and exchange comments, links, music, video, data and all other kinds of information. The social network database 132 may store, among other things, social network data and/or user profile data, including personal information such as the first name and last name of the user, a valid email address, a unique user identifier within the social network, birth date, gender, occupation, etc. The user profile data may further include interest information, which may include, but is not limited to, activities, hobbies, photos, etc. The social network database 132 may also store a user's social network contacts, which may include, without limitation, a list of friends within the social network, a list of family within the social network, a list of acquaintances within the social network, a total number of contacts within the social network.

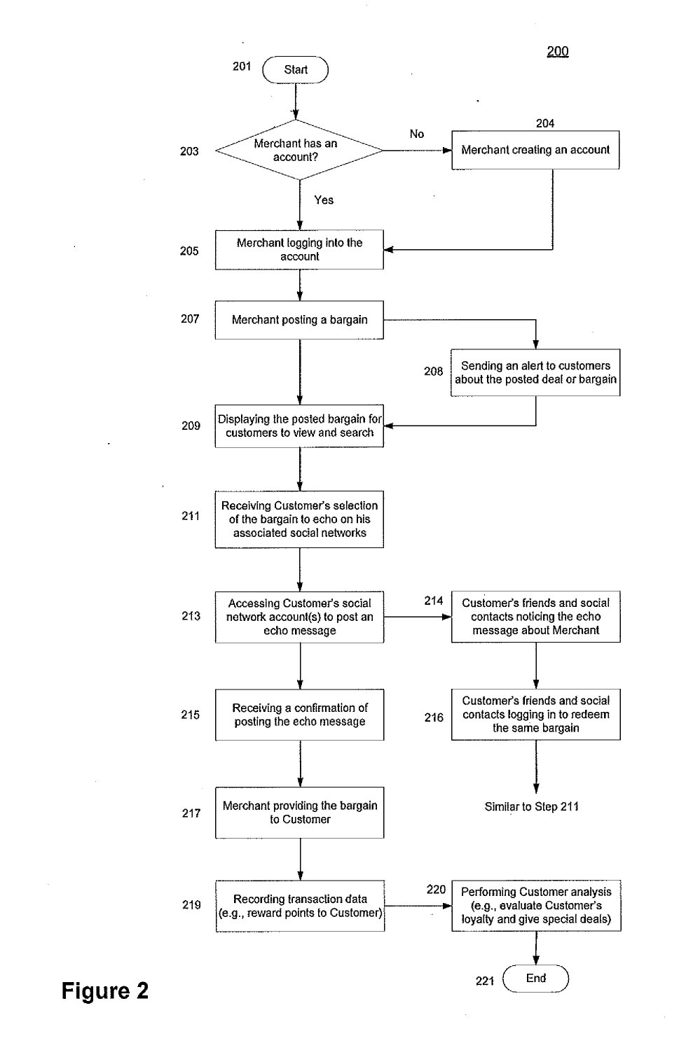

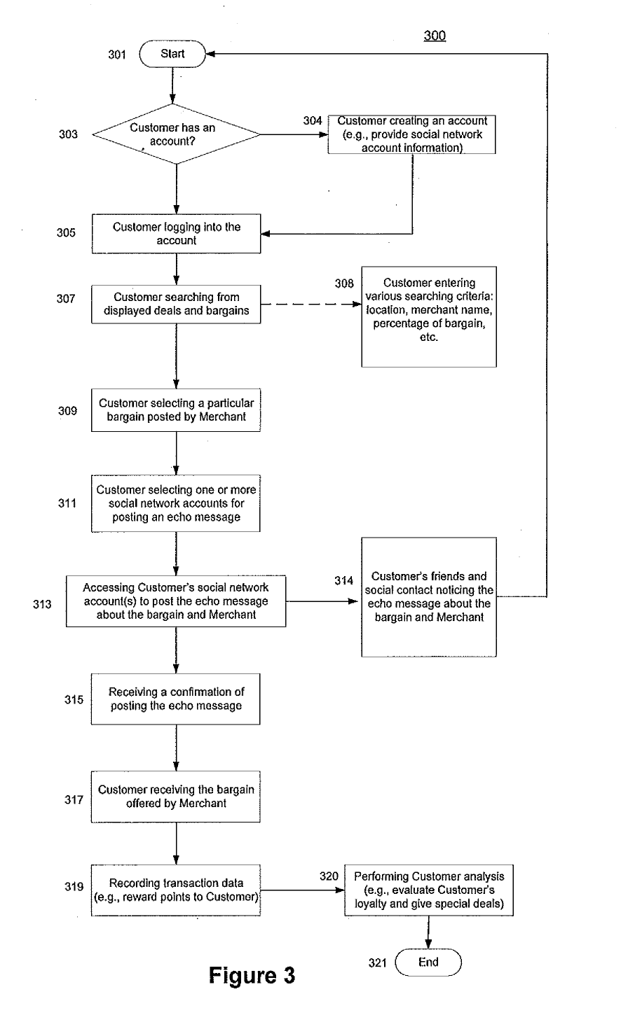

The system 100 also comprises the application server 120 and one or more application databases 122 for storing application data. The application server 120 is configured with computer software, executable programs, algorithms, functional modules and processes allowing a merchant to market its brands, products and/or services via its customers' social network accounts. For example, the application server 120 may be programmed with exemplary processes as shown in FIGS. 2 and 3, which will be described in detail below. Upon authorization of registered users, the application server 120 is also capable of accessing the social network data of those users from the social network server 130 and database 132. The application database 122 stores user data for registered customers and merchants, such as their user profiles (e.g., user names and passwords), deal or bargain information posted by respective merchants, redemption or acceptance of deals or bargains by respective customers, echo messages posted by customers on their social network sites, frequency of echoing deals or bargains by respective customers, and the like. In one embodiment, the application server 120 is maintained by a third-party service provider or company. The clients or users can be merchants 140 and customers 150. The application interface can be provided at a website accessible over the Internet. Or it can be downloaded and installed in a mobile device. In the latter case, the mobile application can be provided in various versions to be compatible with different mobile operating systems such as Apple iOS, Android or Windows.

It should be appreciated that the system 100 in FIG. 1 is for illustration only and can be implemented with many variations without departing from the spirit of the invention. For instance, the social network server 130 and application server 120 each can include multiple computers and stations distributed in different locations.

FIG. 2 is a flow diagram of an exemplary process from a merchant's perspective how to use the inventive application for marketing or promoting its business via customers' social network platforms. In operation, a merchant can use the inventive application from a website using the Internet access or download the application into its mobile terminal, a tablet computer, for example.

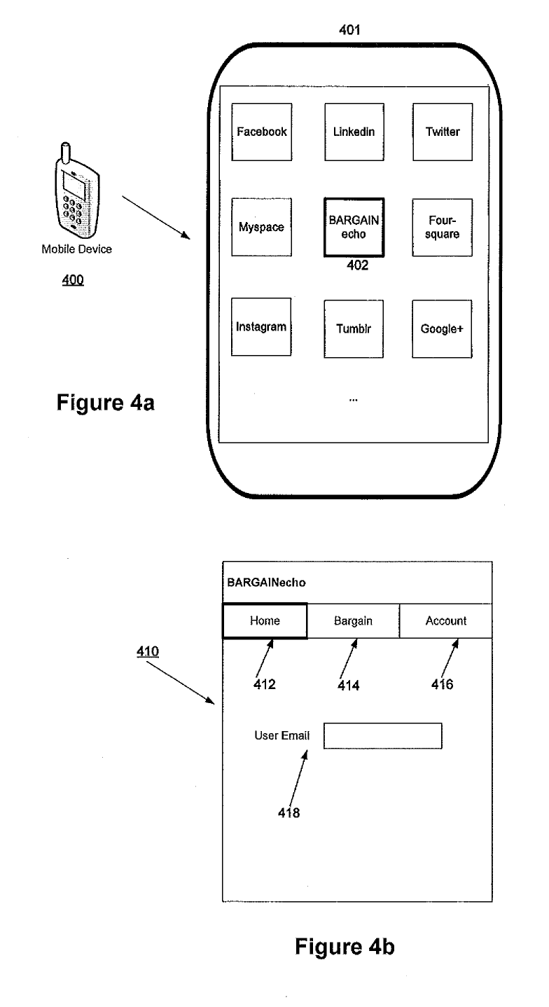

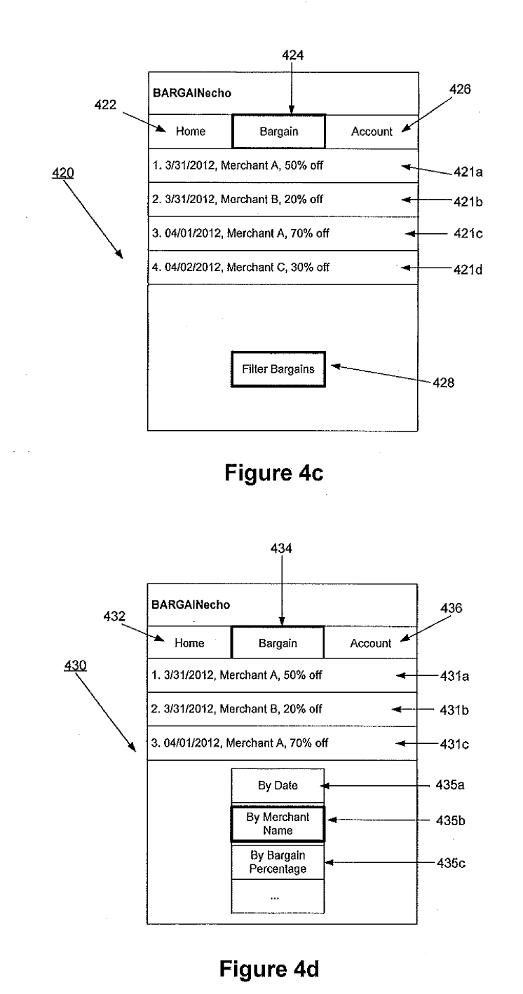

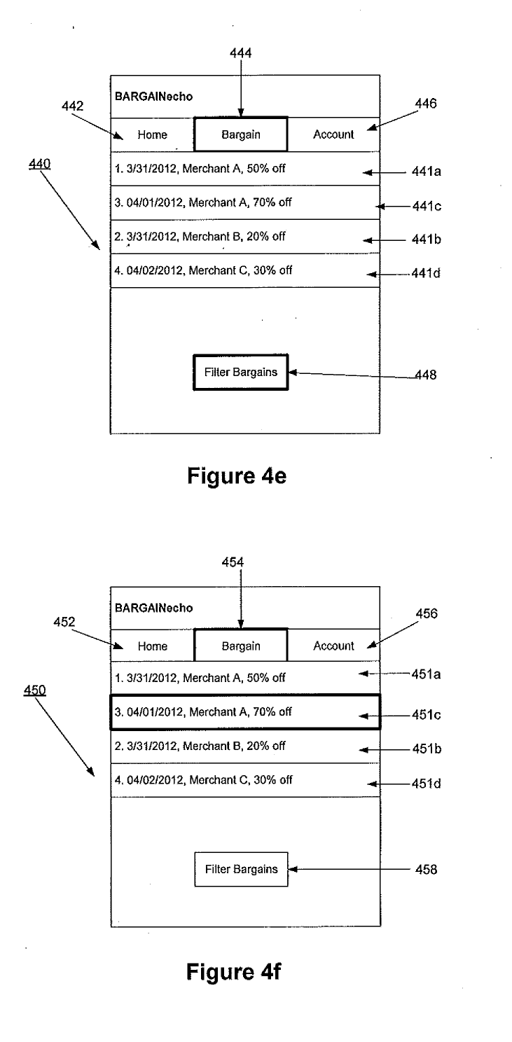

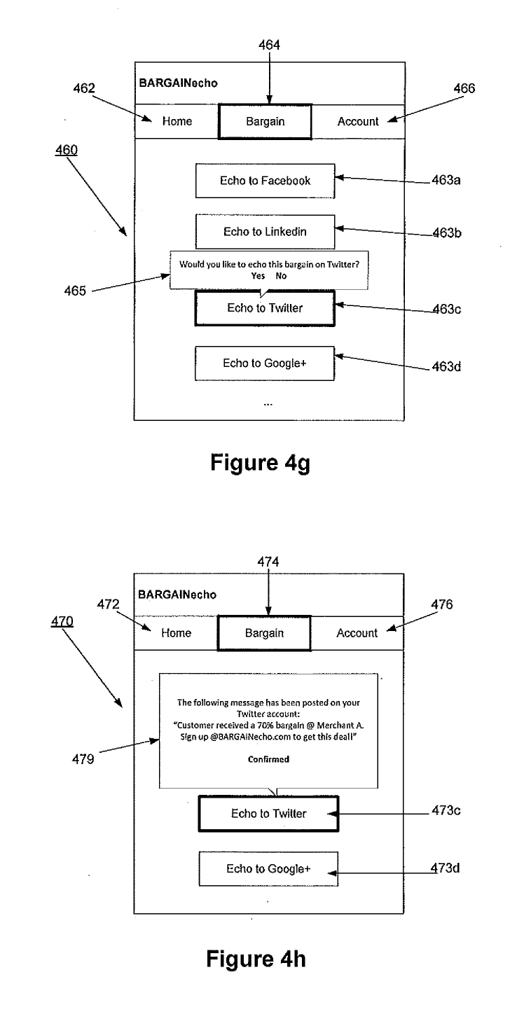

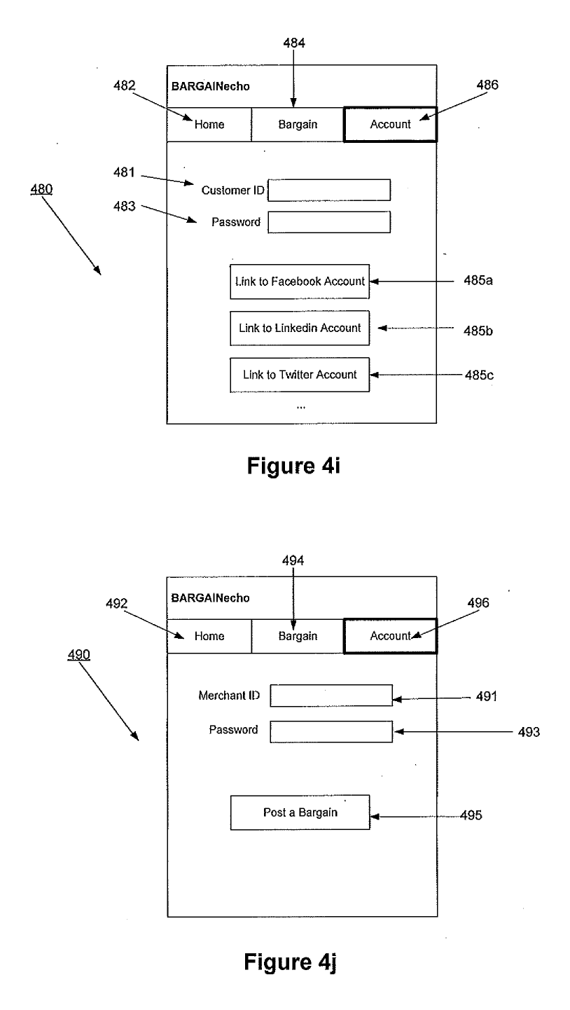

As shown in FIG. 2, the process 200 starts at step 201, followed by an initial inquiry whether the merchant has an existing account at step 203. If the merchant has not yet signed up, the process proceeds to step 204 at which the merchant can create an account. Typically, the merchant needs to provide a user identifier (for example, an email address) and a matching password. Other contact information, such as the business address and description of products and services, may be needed for building the merchant profile. Once the merchant has successfully created an account, at step 205 the merchant can log into its account by filling out verification data such as a valid user name and password. At step 207, the merchant may choose to submit deal information or a bargain item by creating a promotional message. Alternatively, the application can automatically generate such a message once the merchant fills out a standard form of questions regarding the deal or bargain to be offered. At step 208, the application may send an alert message to customers that agree to receive automatic notifications of newly-posted deals or bargains. This step can be optional depending on each customer's preferred system settings in the application. At step 209, the deal or bargain information will be displayed on the bargain or deal list of the application for customers to view, select or search from, as illustrated in FIGS. 4c-h, which will be described in detail below.

After a customer selects a particular bargain item for echoing on his or her social network sites, the application recognizes the customer's selection at step 211. The application may also alert the customer with a confirmation request whether the customer wishes to post an echo message to one or more of his/her social network accounts. After confirmation by the customer, the application can access the customer's social network account(s) to post the echo message at step 213. An exemplary echo message can be “Customer just received 50% off at Merchant A. Sign up at BARGAINehco.com to redeem this deal.” Subsequently to posting the message, at step 214, the customer's friends and contacts may view the posted message and become aware of the merchant and the deal or bargain offered by the merchant. Then at step 216, these friends and contacts may decide to sign up for the echo application so as to redeem the same bargain or deal from the merchant, following a similar process starting at step 211.

Back to the customer's selection of a bargain item at step 211, in one embodiment, the customer can make the selection at the point of sale, which likely occurs when he or she is at the merchant's site and ready for redeeming the deal. For example, the customer may be at a restaurant, and at the time of paying the dinner bill, he or she can press or touch the echo icon (as shown in FIGS. 4g-h) in the presence of a waiter or waitress who can immediately see the confirmation that an echo message is posted on the customer's social network account(s), as received at step 215. With that confirmation, at step 217 the merchant (or the restaurant owner in this example) can apply whatever discount set forth in the bargain item to the customer's bill of purchase. Alternatively, the customer may select a deal or bargain item to echo on his or her social websites, while he or she is away from the physical point of sale. In that case, the customer may receive a unique security or verification code along with the confirmation that the echo message has been posted successfully. This security or verification code allows the merchant to verify and honor the discount or credit as offered in the posted bargain item. For example, before the customer purchases a book from an online book store, he may select the bargain item offered by the book store (e.g., 50% off) and receive a verification code after the echo message is posted on his social website(s). Then at the checkout point, the customer can enter the verification code to receive the discount by the online bookstore. In other words, the confirmation indicative of the echo message being posted can be provided by either a merchant's representative actually viewing the confirmation message or a unique verification code provided to the customer.

After the merchant provides the bargain to the customer at step 217, the application generates the transaction data and stores the data in the application database at step 219. For example, the application calculates reward points based on the customer's echo messages and records the points in the customer's account. In one embodiment, the redeemed bargain item may be removed from the customer's mobile display if the merchant limits the bargain to be used only once per customer. Then the process continues to step 220 where the application may perform comprehensive analyses based on the customer data in the application database for the merchants' benefit. For example, the application can evaluate whether a customer is an effective and loyal marketing assistant for the merchant by tracking certain data points, such as how frequent the customer would echo a deal or bargain on his or her social networks, how many social connections this customer has actively maintained, how many of his social connections become the merchant's customers resulting from the echo messages, and the like. The application may further divide the customer profiles into different levels based on numerous factors, such as their locations, echo frequency, marketing effectiveness points, and so forth. Merchants can choose whether to offer special deals to select customers based on the analyzed results. Finally, the process ends at step 221.

It should be appreciated that the process 200 in FIG. 2 is for illustration only and can be implemented with many variations without departing from the spirit of the invention. For instance, the process 200 may include fewer or more steps than what is illustrated in FIG. 2. Also, despite the step labels, there is no strict order of performing the illustrated steps, and some steps can be performed concurrently with others.

FIG. 3 is a flow diagram of an exemplary process 300 from a customer's perspective how to use the inventive application for receiving bargains and deals offered by various, merchants and sharing the same with his or her social connections. In operation, a customer can use the inventive application from a website using the Internet access or download the application into his or her mobile device, a smart phone, for example.

As seen in FIG. 3, the process 300 starts at step 301. At step 303, the customer is faced with an initial inquiry whether he or she has an existing account. If the customer has not yet signed up, the process proceeds to step 304 for the customer to create an account. Typically, the customer needs to provide a user identifier (for example, an email address) and a matching password. Alternatively, an email account of the customer is adequate for using the application. Other contact information, such as the customer's home address and telephone number, may be needed for building the customer profile. At this step or later in the process, the customer may also be asked to provide his or her social network account information. For instance, the customer may choose to link the application with his or her Facebook account, LinkedIn account, Twitter account or any other social network account. Once the customer account is established, at step 305 the customer can log into the account. Then, at step 307 the customer can view a list of deal or bargain items on his or her mobile device. Typically, these displayed deals or bargains are sorted by certain orders, such as by dates of submission or dates of expiration. The customer is allowed to further sort the deals by entering his or her own criteria at step 308. For instance, the customer can choose a location (e.g., a city or an address) for viewing all local deals or bargains. Alternatively, the application automatically locates the customer using the GPS capabilities. The application can also allow the customer to manually change locations. The customer can also search for deals or bargains provided by a particular merchant, a particular product or service category, a discount percentage, and the like.

At step 309, the customer selects a particular bargain or deal item from his or her mobile device. Typically, the customer makes the selection by touching or pressing a displayed deal or bargain item. In one embodiment, the customer has only one or a default social network account for posing the echo message. In other embodiments, the customer may have multiple social network account(s) to choose from, as shown in step 311. In that case, the customer will be asked to choose one or more social network account(s) for posting the echo message. An exemplary echo message can be “Customer just received 50% off at Merchant A. Sign up at BARGAINehco.com to redeem this deal.” Subsequently to posting the message, at step 314, the customer's friends and contacts may view the posted message and become aware of the merchant and the deal or bargain offered by the merchant. These friends and contacts may decide to sign up for the echo application to redeem the same bargain or deal from the merchant, following a similar process starting at step 301.

After the echo message is posted on the customer's social website(s), the customer receives a confirmation message at step 315. Similar to the process in FIG. 2, the customer may select the bargain item at the point of sale, which involves the merchant's representative (e.g., a sales person) actually viewing the confirmation, or away from the point of sale, in which case, a verification code coming with the confirmation message needs to be provided in order to receive the deal or bargain. At step 317, the customer receives the deal or bargain from the merchant. Similarly, at step 319 the application generates the transaction data and stores the data in the application database. For example, the application calculates reward points based on the customer's echo messages and records the points in the customer's account. In one embodiment, the redeemed bargain item may be removed from the customer's mobile display if the merchant limits the bargain to be used only once per customer. Also, at step 320, the application may perform comprehensive analyses based on the customer data in the application database for the merchants' benefit. For example, the application can evaluate whether a customer is an effective and loyal marketing assistant for the merchant by tracking certain data points, such as how frequent the customer would echo a deal or bargain on his or her social networks, how many social connections this customer has actively maintained, how many of his social connections become the merchant's customers resulting from the echo messages, and the like. The application may further divide the customer profiles into different levels based on numerous factors, such as their locations, echo frequency, marketing effectiveness points, and so forth. Merchants can choose whether to offer special deals to select customers based on the analyzed results. Finally, the exemplary process 300 ends at step 321.

It should be appreciated that the process 300 in FIG. 3 is for illustration only and can be implemented with many variations without departing from the spirit of the invention. For instance, the process 300 may include fewer or more steps than what is illustrated in FIG. 3. Also, despite the step labels, there is no strict order of performing the illustrated steps, and some steps can be performed concurrently with others.

FIGS. 4a-j provide exemplary screen shots of a mobile application for implementing embodiments of the invention in a mobile device. It should be understood that these screen displays in FIGS. 4a-j are for illustration only and by no means limit or otherwise define the inventive embodiments. As will be appreciated, many variations of these screen shots can be applied in terms of implementing various embodiments of the invention.

Starting from FIG. 4a, a user may have a mobile device 400 having a user interface, such as the touch screen 401. On the main page of the touch screen 401, displayed are multiple application icons, such as Facebook, LinkedIn, Twitter, and the like. The echo application 402 can be easily downloaded and installed in the mobile device from an application store (e.g., Apple App Store, iTunes, Android App Store, Amazon store). By touching, tapping, clicking or pressing the icon 402, a user can activate the echo application programmed to execute some of the steps in the exemplary processes in FIGS. 2-3.

FIG. 4b shows a screen display 410 of the home page when the application is activated. As illustrated in FIG. 4b, the application page is configured with three touch sensitive buttons or tabs 412 (“Home”), 414 (“Bargain”) and 416 (“Account”), although it should be understand that varied configurations can be employed. Under the “Home” button or tab 412, a user provides an account identifier, such as an email address, in order to log into the account as a customer or a merchant. If the user has not created an account, he or she may tap on the “Account” button or tab 416, where a new account can be created following step-by-step instructions. Usually the user account has been created when the application is downloaded and installed in the user-specific mobile device. As with most other mobile applications, the echo application may already contain user information and does not need verify the user every time. By tapping on the “Bargain” button or tab 414, a user may view a list of bargain items as shown in FIG. 4c.

The screen display 420 in FIG. 4c presents a list of bargain items 421a, 421b, 421c and 421d under the “Bargain” button or tab 424. It should be understood that the displayed bargains 421a-d are for illustration only, and in real implementation, many more deal or bargain items may be displayed. The displayed deals or bargains 421a-d are sorted by some default standard such as expiration dates or submission dates. By tapping or touching on the “Filter Bargains” icon 428, a customer user can further sort or filter out the bargains based on his or her own criteria. For example, the screen display 430 in FIG. 4d shows that the customer can filter out bargains by date 435a, by merchant name 435b, by bargain percentage 435c, and the like. If the customer chooses “By Merchant Name” 435b, FIG. 4e shows a different screen display 440 in which the bargains 441a-d are sorted and displayed in a different order, with two bargains 441a and 441b by Merchant A presented on the top of the list.

The customer can select from the displayed list of bargains for echoing on his or her social networks before redeeming the deal. As shown in FIG. 4f, the customer user has selected the deal or bargain item 451c “Apr. 1, 2012, Merchant A, 70% off.” Following this selection, the customer may be presented with a screen display 460 in FIG. 4g, in which the customer can further choose which social network account to be used for posting an echo message. For example, the customer can choose from 463a “Echo to Facebook,” 463b “Echo to LinkedIn,” 463c “Echo to Twitter,” and 463d “Echo to Google+.” It should be understood that many other social network accounts can be provided in this screen display depending on the customer's initial settings. After the customer selects one or more social network account(s) to echo the bargain on his or her selected social website(s), he or she may receive an alert message 465 to confirm the customer's intention to do so. FIG. 4h shows a confirmation message 479 once the echo message is posted on the customer's social network site(s). As described above, the merchant's representative at the point of sale needs to view this message before applying the offered discount in the bargain. In certain embodiments, the customer may receive a verification code along with the confirmation message and provide the verification code at the checkout point.

FIG. 4i presents a customer view of the account page in the screen display 480. When the user is a customer, he or she will be presented with an account tab 486 including user information, such as customer ID 481 and password 483, and the user's social network account settings, such as 485a “Link to Facebook Account,” 485b “Link to LinkedIn Account,” 485c “Link to Twitter Account,” and the like. On the other hand, FIG. 4j provides a merchant view of the account page. Under this account tab 496, the merchant user can provide a merchant ID 491 and password 493. The merchant can also touch or tap on the icon 495 to submit or post a bargain item. As described above, the merchant may create its Own bargain message or allow the application to generate an automatic message using the merchant-provided deal or bargain information. Preferably, the merchant can enter the bargain information more easily through the web access instead of a mobile application as illustrated in FIG. 4h. However, the mobile application provides the merchant with additional ways to quickly respond to the market situation by adding deals or bargains at any time and in any location.

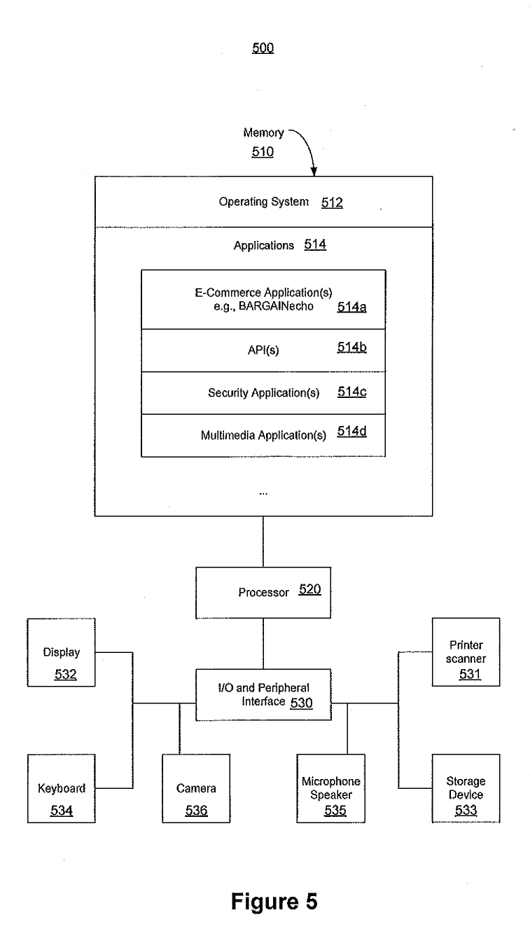

FIG. 5 is a simplified functional block diagram of an exemplary computer programmed or configured to execute a portion of the exemplary processes of FIGS. 2-3. This exemplary computer 500 can also be implemented as the application server 120 in the exemplary system of FIG. 1. It should be noted that the computer 500 is for illustration only, and many computer components included therein may not be shown or described in the following paragraphs.

As shown in FIG. 5, the computer 500 comprises a memory 510, a processor 520 capable of accessing the memory 510, and one or more I/O interfaces or other peripheral interfaces 530 coupled to the processor 520. Exemplary external or peripheral devices include, without limitation, a display 532, a keyboard 534, a camera 536, a printer or scanner in a combined or separate form 531, a storage device 533 such as a USB or disk, and a microphone or speaker 535. The memory 510 includes software programs or drivers for activating and communicating with each peripheral device. In one configuration, these components are connected through one or more communication buses (not shown) in the computer, which may include circuitry that interconnects and controls communications between different components.

The memory 510 includes high-speed random access memory, such as DRAM, SRAM, DDR RAM and/or other random access solid state memory devices; and includes non-volatile memory, such as flash memory devices, a magnetic disk storage device, and/or other non-volatile solid state storage devices. The memory 510, or alternately non-volatile memory device(s) within the memory 510, includes a non-transitory computer-readable storage medium. While the memory 510 is shown as being separate from the processor 520, all or a portion of the memory 510 may be embedded in the processor 520. In some embodiments, the memory 510 stores the following programs, modules and data structures, or a subset thereof: an operating system 512 that includes procedures for handling various basic system services and for performing hardware dependent tasks, and applications 514, including one or more e-commerce applications 514a (e.g., the BARGAINecho application) and corresponding APIs 514b for processing data received from other devices and data to be transmitted to the other devices, security applications 514c, and/or multimedia applications 514d. In some embodiments, the non-transitory computer-readable storage medium of the memory 510 includes instructions for performing all or a portion of the operations in the exemplary processes 200 and 300 in FIGS. 2 and 3. The processor 520 is configured to access and execute the instructions, programs, applications, and modules stored in the memory 510.

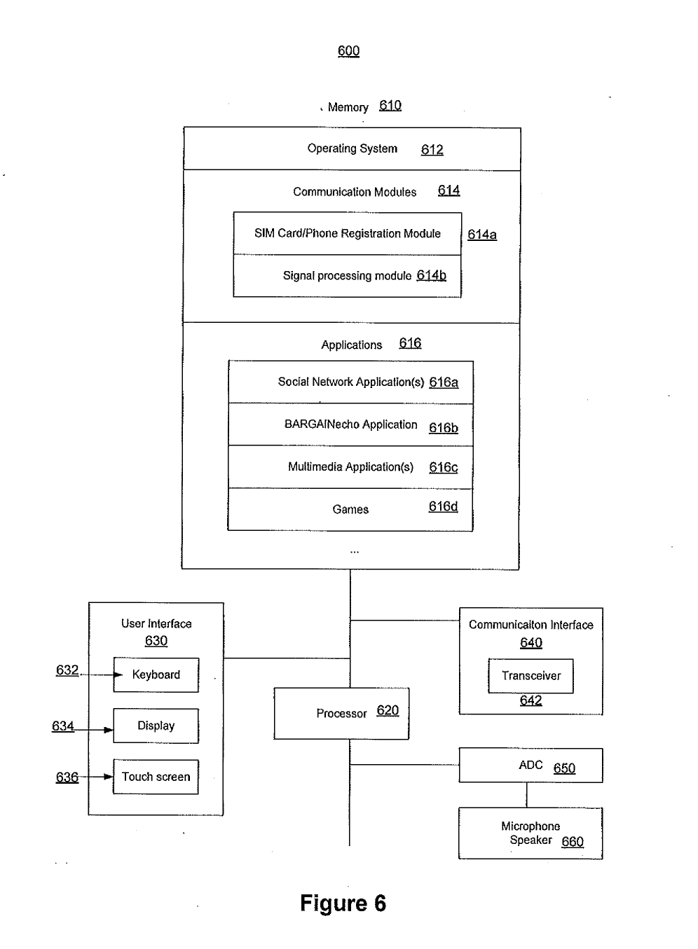

FIG. 6 is a simplified functional block diagram of an exemplary mobile device programmed or configured to execute a portion of the exemplary processes of FIGS. 2-3. This exemplary mobile device 600 can also be implemented in the exemplary system of FIG. 1 for users (merchants and customers) to connect to the network and different application servers in the network. It should be noted that the device 600 is for illustration only, and many device components included therein may not be shown or described in the following paragraphs.

As shown in FIG. 6, the exemplary device 600 comprises a memory 610, a processor 620 capable of accessing the memory 610, a user interface 630, a communication interface 640, an Audio to Digital Converter (ADC) 650 and a microphone or speaker 660 connected to the ADC. In one configuration, all device components are connected through one or more communication buses (not shown) that may include circuitry that interconnects and controls communications between different components.

The memory 610 includes high-speed random access memory, such as DRAM, SRAM, DDR RAM and/or other random access solid state memory devices; and includes non-volatile memory, such as flash memory devices, a magnetic disk storage device, and/or other non-volatile solid state storage devices. The memory 610, or alternately non-volatile memory device(s) within the memory 610, includes a non-transitory computer-readable storage medium. While the memory 610 is shown as being separate from the processor 620, all or a portion of the memory 610 may be embedded in the processor 620. In some embodiments, the memory 610 stores the following programs, modules and data structures, or a subset thereof: an operating system 612 that includes procedures for handling various basic system services and for performing hardware dependent tasks, communication modules 614 used for communicating with other devices or network controllers via the communications interface 640, such as a SIM card or phone registration module 614a and a signal processing module 614b, and applications 616, including one or more social network applications 616a, the BARGAINecho application 616b, multimedia applications 616c and games 616d. All these applications may have associated API(s) (not shown) in the memory 610.

In some embodiments, the non-transitory computer-readable storage medium of the memory 610 includes instructions for performing all or a portion of the operations in the exemplary processes 200 and 300 in FIGS. 2 and 3. The processor 620 is configured to access and execute the instructions, programs, applications, and modules stored in the memory 610. Through the user interface 630, the processor 620 is coupled to one or more of the following: a keyboard 632, a display 634 and a touch screen 636. The processor 620 is also coupled to a transceiver 642 via the communication interface 640.

While various embodiments of the invention have been described above, it should be understood that they have been presented by way of example only, and not by way of limitation. Likewise, the various diagrams may depict an example architectural or other configuration for the disclosure, which is done to aid in understanding the features and functionality that can be included in the disclosure. The disclosure is not restricted to the illustrated example architectures or configurations, but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described. They instead can be applied alone or in some combination, to one or more of the other embodiments of the disclosure, whether or not such embodiments are described, and whether or not such features are presented as being a part of a described embodiment. Thus the breadth and scope of the present disclosure should not be limited by any of the above-described exemplary embodiments.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the invention.

In this document, the terms “computer program product”, “computer-readable medium”, and the like, may be used generally to refer to media such as, memory storage devices, or storage unit. These, and other forms of computer-readable media, may be involved in storing one or more instructions for use by processor to cause the processor to perform specified operations. Such instructions, generally referred to as “computer program code” (which may be grouped in the form of computer programs or other groupings), when executed, enable the computing system.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known”, and terms of similar meaning, should not be construed as limiting the item described to a given time period, or to an item available as of a given time. But instead these terms should be read to encompass conventional, traditional, normal, or standard technologies that may be available, known now, or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to”, or other like phrases in some instances shall not be read to mean that the narrower case is intended or required in instances where such broadening phrases may be absent.

Additionally, memory or other storage, as well as communication components, may be employed in embodiments of the invention. It will be appreciated that, for clarity purposes, the above description has described embodiments of the invention with reference to different functional units and processors. However, it will be apparent that any suitable distribution of functionality between different functional units, processing logic elements or domains may be used without detracting from the invention. For example, functionality illustrated to be performed by separate processing logic elements, or controllers, may be performed by the same processing logic element, or controller. Hence, references to specific functional units are only to be seen as references to suitable means for providing the described functionality, rather than indicative of a strict logical or physical structure or organization.

Furthermore, although individually listed, a plurality of means, elements or method steps may be implemented by, for example, a single unit or processing logic element. Additionally, although individual features may be included in different claims, these may possibly be advantageously combined. The inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A method for promoting products and services via social network platforms, the method comprising:
receiving bargain data from a merchant, the bargain data including one or more bargain items offered by the merchant;
displaying a list of the one or more bargain items in a mobile device of a customer, the customer associated with one or more social network accounts;
receiving a first input that selects at least one of the one or more bargain items;
receiving a second input that authorizes posting an echo message regarding the selected bargain item to at least one of the one or more social network accounts associated with the customer;
in response to the second input, posting the echo message on the at least one social network account associated with the customer; and
allowing the customer to receive the selected bargain item from the merchant.

2. The method of claim 1, further comprising:
generating and recording transaction data after the customer receives the selected bargain item.

3. The method of claim 1, further comprising:
removing the selected bargain item from the displayed list of bargain items after the customer receives the selected bargain item.

4. The method of claim 1, further comprising:
allowing the customer to select one social network account from the one or more social network accounts for posting the echo message.

5. The method of claim 1, further comprising:
in response to the second input, generating the echo message; and
accessing the at least one social network account associated with the customer.

6. The method of claim 1, further comprising:
providing a confirmation message indicating that the echo message has been posted on the at least one of the one or more social network accounts associated with the customer, wherein the merchant provides the selected bargain item upon the confirmation message.

7. The method of claim 6, wherein the confirmation message contains a unique verification code for the customer to receive the selected bargain item from the merchant.

8. The method of claim 1, wherein the echo message posted on the at least one of the one or more social network accounts associated with the customer allows the customer's social connections to receive the selected bargain item.

9. A non-transitory computer readable medium comprising executable instructions, the executable instructions, while executed, causing a processor to perform:
receiving bargain data from a merchant, the bargain data including one or more bargain items offered by the merchant;
displaying a list of the one or more bargain items in a mobile device of a customer, the customer associated with one or more social network accounts;
receiving a first input that selects at least one of the one or more bargain items;
receiving a second input that authorizes posting an echo message regarding the selected bargain item to at least one of the one or more social network accounts associated with the customer;
in response to the second input, posting the echo message on the at least one social network account associated with the customer; and
allowing the customer to receive the selected bargain item from the merchant.

10. The non-transitory computer readable medium of claim 9, wherein the executable instructions, while executed, causes the processor to further perform:
generating and recording transaction data after the customer receives the selected bargain item.

11. The non-transitory computer readable medium of claim 9, wherein the executable instructions, while executed, causes the processor to further perform:
deleting the selected bargain item from the displayed list of bargain items after the customer receives the selected bargain item.

12. The non-transitory computer readable medium of claim 9, wherein the executable instructions, while executed, causes the processor to further perform:
receiving a third input from the customer that selects one social network account from the one or more social network accounts for posting the echo message.

13. The non-transitory computer readable medium of claim 9, wherein the executable instructions, while executed, causes the processor to further perform:
in response to the second input, generating the echo message; and
accessing the at least one social network account associated with the customer.

14. The non-transitory computer readable medium of claim 9, wherein the executable instructions, while executed, causes the processor to further perform:
providing a confirmation message indicating that the echo message has been posted on the at least one of the one or more social network accounts associated with the customer, wherein the merchant provides the selected bargain item upon the confirmation message.

15. The non-transitory computer readable medium of claim 14, wherein the confirmation message contains a unique verification code for the customer to receive the selected bargain item from the merchant.

16. A device comprising:
a screen display;
a memory comprising executable instructions; and
a processor configured to execute the executable instructions in the memory, the processor further configured to:
display a list of bargain items on the screen display;
receive an input from a user that selects at least one of the displayed bargain items, wherein the input authorizes posting an echo message regarding the selected bargain item to at least one social network account associated with the user; and
access the at least one social network account associated with the user to post the echo message, wherein the user redeems the selected bargain items after the echo message is posted.

17. The device of claim 16, wherein the processor is further configured to receive bargain data from a merchant, the bargain data including one or more bargain items offered by the merchant.

18. The device of claim 16, wherein the processor is further configured to display a confirmation message indicating that the echo message has been posted on the at least one of the one or more social network accounts associated with the user.

19. The device of claim 18, wherein the user receives the selected bargain item from a merchant based on the confirmation message.

20. The device of claim 16, wherein the processor is further configured to record transaction data in the memory after the user receives the selected bargain item, and remove the selected bargain item from the displayed list of bargain items.
